(19) United States
(12) Patent Application Publication
(10) Pub. No.: US 2017/0316298 A1
(43) Pub. Date: Nov. 2, 2017

(54) MEASURING DEVICE AND AN EXECUTION METHOD THEREOF

(71) Applicant: Tzu Ping CHU, Kaohsiung (TW)

(72) Inventor: Tzu Ping CHU, Kaohsiung (TW)

(73) Assignee: Tzu Ping CHU, Kaohsiung (TW)

(21) Appl. No.: 15/140,536

(22) Filed: Apr. 28, 2016

(51) Int. Cl. G06K 19/07; A61J 7/04; G01C 19/56; G06F 19/00

(52) U.S. Cl. CPC G06K 19/0727; G06F 19/3462; A61J 7/04; G01C 19/56

(57) ABSTRACT

The present disclosure relates to a measuring device and an execution method thereof characterized in that open/close status of a cover body over a can body is recognized, the cover body is unscrewed or extracted from the can body, status of the cover body separated from the can body is detected by an electronic module mounted on the cover body, and the electronic module transmits a message to an appliance with the cover body totally separated from the can body.

### BACKGROUND OF THE INVENTION

### 1) Field of the Invention

The present disclosure offers a measuring device and an execution method thereof that depend on an electronic module at a cover body to recognize open/close status of a can body from which the cover body is screwed and extracted and further transmit a message of open/close status from the electronic module to an appliance for display.

### 2) Description of the Prior Art

In virtue of the aging population and heavy work intensity, modern people have paid more attentions to medical treatment, lifetime living planning and preservation of health care than before. Moreover, the illness caused by modern civilization such as chronic disease is characteristic of protracted ill conditions of a patient who may not fall ill but perceive threat of sickness continuously. In this regard, most geriatric diseases are attributed to a patient who failed to take care of the body in his/her youth and suffers the diseases after a long time; however, the trend of disease progression displays more and more young people coming down with geriatric diseases. In addition, people are beset by numerous health-care or nutritional supplements and complicated medication frequency.

People who need either medicines for chronic disease or nutritional supplements have to take pastilles held in containers or drink potable medicinal liquids; in general, medication adherence probably causes problems when patients forget taking or repeatedly take pastilles inside a can body.

There have been patents for pastille containers as follows:

Taiwan Patent No. M363913 discloses a pill container which comprises a container body with a plurality of containing chambers inside, a sealing cover, and a cover body with an open/close mechanism. Each of the containing chambers is designed as a cavity inside the container body for accommodating pills, pastilles or capsules. The sealing cover, which is a rotary component to seal the container body, has a through hole through which each of the containing chambers is connected. Furthermore, the sealing cover is marked with a scale corresponding to the containing chambers. The open/close mechanism is used to open/close the through hole on the sealing cover through which pills inside are reached. To take and estimate remaining pills inside a containing chamber quickly and manage the medicine dosage effectively, a user should rotate the sealing cover and aim the through hole at a distinct containing chamber.

Taiwan Patent No. M381602 discloses a container lid and a pill container for the container lid wherein the container lid is mounted on the pill container to correctly indicate regular medication time. The container lid comprises an external lid and an internal lid. The external lid has a base wall and a peripheral wall: the base wall or the peripheral wall is penetrated for installation of a window; the base wall is provided with an inner rugged portion at the inner bottom. The internal lid has a base wall and a peripheral wall: the base wall or the peripheral wall is marked with a scale for regular medication time; the base wall is provided with an outer rugged portion at the outer top. The scale for regular medication time on the internal lid is opposite to the window on the external lid; the outer rugged portion at the internal lid is opposite to the inner rugged portion at the external lid.

Taiwan Patent No. M476599 discloses a smart display device on a pill container. The display device comprises an external lid and an internal body: the external lid comprises a hollowed-out window thereon; the internal body is marked with several signs which are correspondingly displayed on the hollowed-out window. When the external lid is turned to lock the pill container, each of the signs for status of pills taken by a user is switched and displayed on the hollowed-out window automatically without the problem of any overdose which was not recorded in the past.

Taiwan Patent No. M377396 discloses a modified lid on a pill container which is a structure to display the frequency of a lid separated from a pill container and status of pills taken by a user for status of medication as well as hints of indications but neither drug misuses nor repeated doses.

The abovementioned patents, however, are techniques for a counter on a structural body mostly which have nothing to do with prevalent health care information management but are easily lost in too many pastille containers. Thus, the simple and practical idea is not presented in these patents.

To address the above issues, a measuring device and an execution method thereof is provided in the present disclosure.

### SUMMARY OF THE INVENTION

In virtue of above issues, the present disclosure offers a measuring device and an execution method thereof, characterized in that: a cover body is screwed or extracted from a can body; an electronic module mounted on the cover body detects status of the movable cover body and transmits a message for the cover body totally separated from the can body to an appliance.

The present disclosure is to provide a measuring device and an execution method thereof, characterized in that both open/close status of a can body and the frequency of opening/closing the can body are effectively recognized.

The present disclosure is to provide a measuring device and an execution method thereof, characterized in that a simplified structure for attachment of a cover body to a can body reduces costs.

The present disclosure is to provide a measuring device and an execution method thereof, characterized in that wireless communications technology for links and controls facilitates a configuration process by a user and management costs.

The present disclosure is to provide a measuring device and an execution method thereof, characterized in that a speaker unit is integrated for a search function.

The present disclosure is to provide a measuring device and an execution method thereof, characterized in that push buttons for controls simplify a configuration process.

The present disclosure is to provide a measuring device and an execution method thereof, characterized in that an electronic system reinforces follow-up interactive applications.

To this end, a measuring device is embodied with technical measures as follows. A measuring device in the present disclosure comprises a cell and an electronic module with a gyroscope, an active unit and a substrate electrically connected to the cell, the gyroscope and the active unit and is characterized in that: the electronic module is mounted on a cover body over a can body for electric conduction of the gyroscope and the active unit via the cell when the can body needs to be opened/closed; the active unit is to recognize open/close status of the can body according to information such as displacement sent back by the gyroscope.

Moreover, a measuring device further depends on following technical measures to realize purposes and techniques.

In the measuring device, the measuring device comprises a housing to accommodate the cell and the electronic module at one side.

In the measuring device, the measuring device comprises a connection interface at a side wall of the housing.

In the measuring device, the electronic module comprises a wireless communications unit electrically connected to the substrate.

In the measuring device, the electronic module comprises a speaker unit electrically connected to the substrate.

In the measuring device, the electronic module comprises at least a push button electrically connected to the substrate and shown on the exterior of the cover body.

In the measuring device, the electronic module comprises a recording unit electrically connected to the substrate.

In the measuring device, there can be an extra appliance electrically connected to the substrate and shown on the exterior of the cover body.

In the measuring device, the appliance can be a display unit, a mobile phone, a tablet computer, a laptop computer or a watch.

An execution method of a measuring device to recognize open/close status of a cover body over a can body in which a cell and an electronic module are held comprises steps as follows: step 1, the active unit and the gyroscope in the electronic module are activated by electricity from the cell; step 2, the cover body is unscrewed or extracted from the can body; step 3, open/close status of the cover body over the can body is analyzed with information such as number of turns or resistance variation received by the active unit; step 4, the electronic module sends a message to an appliance when the cover body is totally separated from the can body.

Moreover, an execution method of a measuring device depends on following technical measures to realize purposes and techniques.

In the execution method of a measuring device, the message in step 4 comprises information such as frequency, occurrence time or object held inside.

In contrast to conventional techniques, a measuring device and an execution method thereof are characteristic of effects as follows: (1) a measuring device with simplified modular structure which is available in any container for its functions; (2) wireless electronic transmission for connection of an external appliance and statistic analysis; (3) simplification of raw materials for reduced costs; (4) wireless communications and an integrated speaker unit to find a lost component easily.

### BRIEF DESCRIPTIONS OF THE DRAWINGS

FIG. 1 is a first schematic structural view of a measuring device in a preferred embodiment;

FIG. 2 is a first perspective view of a measuring device in a preferred embodiment;

FIG. 3 is a first exploded view of a measuring device in a preferred embodiment;

FIG. 4 is a second schematic structural view of a measuring device in a preferred embodiment;

FIG. 5 is a third schematic structural view of a measuring device in a preferred embodiment;

FIG. 6 is a second exploded view of a measuring device in a preferred embodiment;

FIG. 7 is a third exploded view of a measuring device in a preferred embodiment;

FIG. 8 is a flowchart for an execution method of a measuring device in a preferred embodiment.

### DETAILED DESCRIPTIONS OF THE PREFERRED EMBODIMENTS

A measuring device and an execution method thereof will be further explained in preferred embodiments for clear understanding of purposes, characteristics and effects.

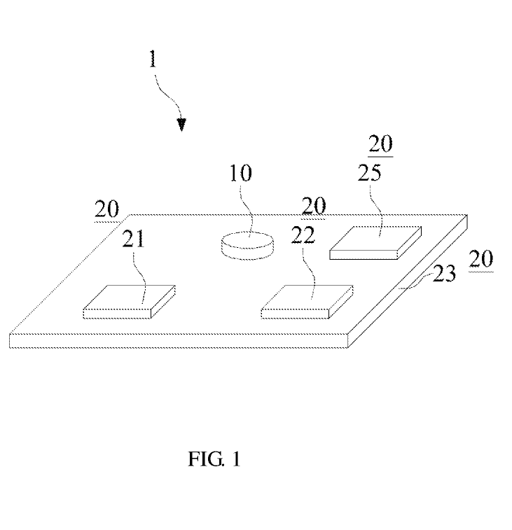

FIGS. 1, 2 and 3 illustrate a measuring device of the present disclosure in the first embodiment. As shown in FIG. 1, a measuring device (1) comprises a cell (10) and an electronic module (20) which has a gyroscope (21), an active unit (22) and a substrate (23).

Specifically, the cell (10) is a component, which transforms internal stored chemical energy to electrical energy in a narrow sense, or a component, which transforms energy stored in advance to electrical energy for external usage in a broad sense; the gyroscope (21) is a micro-mechanical gyroscope or a MEMS (Micro Electro Mechanical System) gyroscope which is manufactured with semiconductor-based chip technologies and provided with a micro-magnetic body for displacement in X, Y and Z directions under the Coriolis force induced by rotary motions and detection of a moving object's direction; the active unit (22) is a microprocessor (μP) with programmable application-specific integrated circuits, which receive and execute coding instructions from one or more terminals and export signals characterizing status of coding instructions; the substrate (23) is a Printed Circuit Board (PCB) which is a major electronic part as a carrier of electronic components and a supplier of electricity for connected electronic components; in the present disclosure, the substrate (23) effectuates electrical connections of not only the cell (10), the gyroscope (21) and the active unit (22) but also other parts such as memristor and non-volatile memory (NVRAM) or passive elements to support normal functions of the electronic module (20).

Referring to FIG. 1 through FIG. 3 which illustrate the electronic module (20) is installed on a cover body (31) over a can body (30) in an embodiment for electric conduction of the gyroscope (21) and the active unit (22) via the cell (10). When the can body (30) is being opened or closed, the active unit (22) depends on information such as number of turns and displacement sent back by the gyroscope (21) to recognize open/close status of the can body (30) wherein the information such as number of turns and displacement describes continuous states of the cover body (31) from staying at the can body (30) to departing from the can body (30) according to combination/separation of the can body (30) and the cover body (31), for example, turning 360 degrees.

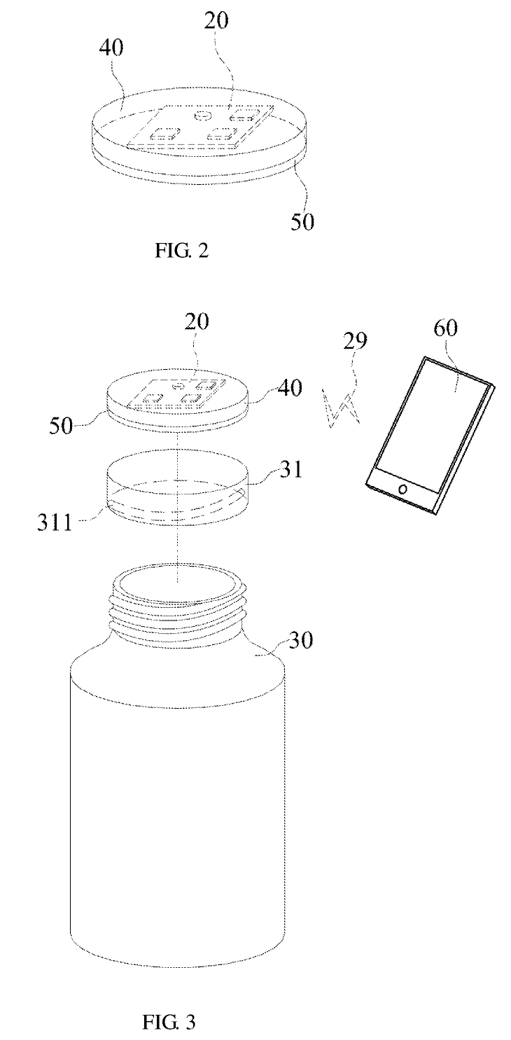

Preferably, as shown in FIGS. 1 and 2, the electronic module (20) is protected in a housing (40) against which the cell (10) and the electronic module (20) are situated at one side; as shown in FIGS. 2 and 3, a connection interface (50) which effectively fixes the electronic module (20) on the cover body (31) is designed on a side wall of the housing (40) and as an adhesive structure, for example, a double-sided adhesive tape and a reused traceless sticker; the electronic module (20) comprises a wireless communications unit (25) which is electrically connected to the substrate (23).

Referring to FIG. 8 which illustrates an execution method of a measuring device in the present disclosure is to recognize open/close status of the cover body (31) over the can body (30) in which the cell (10) and the electronic module (20) are held; the execution method has steps as follows: the active unit (22) and the gyroscope (21) in the electronic module (20) are activated by electricity from the cell (10) (step 1: 701); the cover body (31) is unscrewed or extracted from the can body (30) (step 2: 702); the open/close status of the cover body (31) over the can body (30) is analyzed with information such as number of turns or resistance variation received by the active unit (22) (step 3: 703); the electronic module (20) sends a message (29) to an appliance (60) when the cover body (31) is totally separated from the can body (30) (step 4: 704).

In detail, as shown in FIG. 1 through FIG. 3, both the cell (10) and the electronic module (20) are preferably protected and mounted in the housing (40) and fixed on the cover body (31) through the connection interface (50) at a side wall of the housing (40) wherein the cover body (31) with a thread (311) can be situated at the opening of the can body (30); electronic components on the substrate (23) are electrically conducted by the cell (10); open/close status of the can body (30) is recognized when information such as displacement from the gyroscope (21) is received by the active unit (22) and conformity with defined conditions (for example, turning 360 degrees counterclockwise); information such as frequency, occurrence time or object held inside is transmitted to an appliance (60) by the wireless communications unit (25) for further display and statistic analysis.

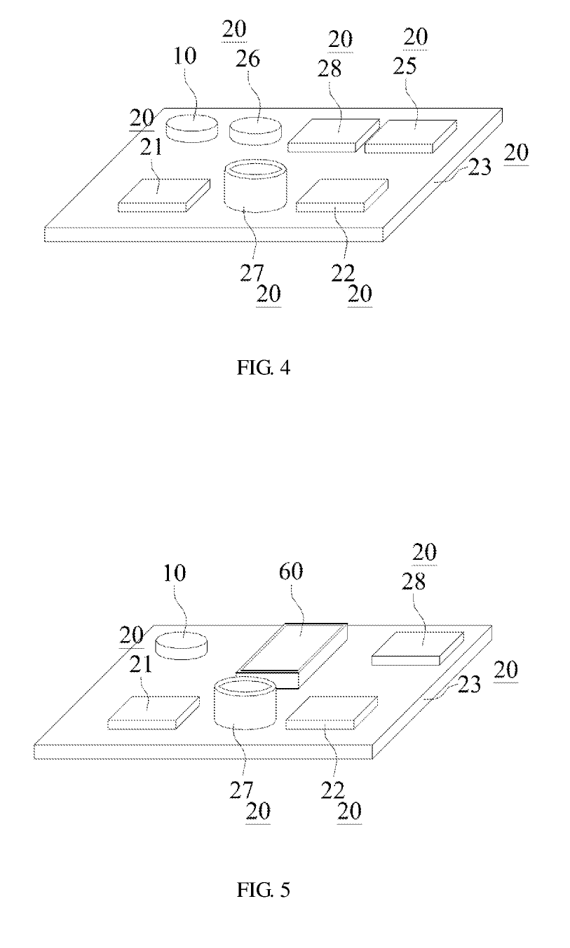

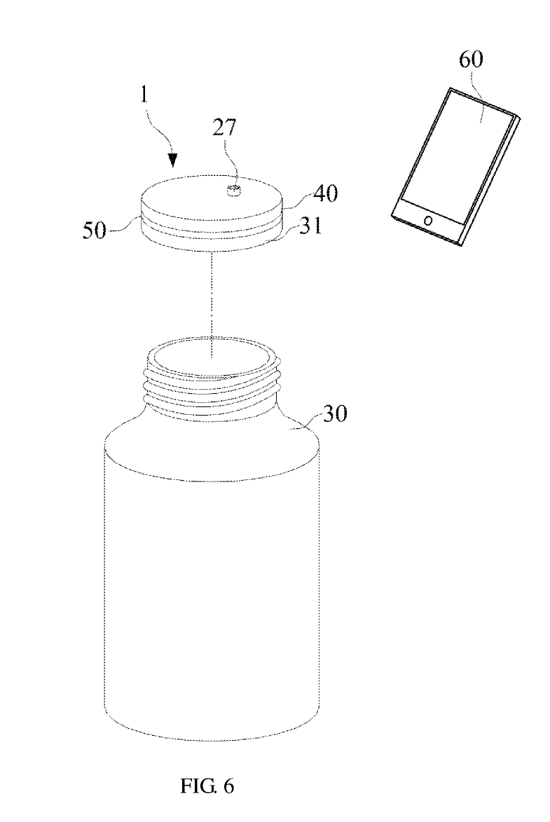

Referring to FIGS. 4 and 6 which illustrate a measuring device of the present disclosure in the second embodiment in which the symbols identical to those of the first embodiment from FIG. 1 to FIG. 3 are not explained hereinafter. The difference in the second embodiment is extra parts added in the electronic module (20) for further interactivity.

Referring to FIG. 4 which illustrates a speaker unit (26), at least a push button (27) and a recording unit (28) are added into the electronic module (20) and electrically connected to the substrate (23) and the push button (27) is shown on the exterior of the cover body (31).

Specifically, the speaker unit (26) is a single speaker which is an energy converter transforming electronic signals to sounds or an audio device consisting of one or several speakers; the push button (27) is an electric switch controlling mechanical or programmable functions; the recording unit (28) comprises volatile memories or non-volatile memories.

Specifically, as shown in FIGS. 4 and 6, both the cell (10) and the electronic module (20) are protected and mounted in the housing (40) and fixed on the cover body (31) through the connection interface (50) at a side wall of the housing (40) wherein the cover body (31) can be situated at the opening of the can body (30); electronic components on the substrate (23) are electrically conducted by the cell (10); the push button (27) shown on the exterior of the cover body (31) is used to connect the wireless communications unit (25) and an appliance (60), for example, smart phone, conveniently; open/close status of the can body (30) is recognized when information such as displacement from the gyroscope (21) is received by the active unit (22) and conformity with defined conditions (for example, turning 360 degrees counterclockwise); information such as frequency, occurrence time or object held inside is transmitted to an appliance (60) by the wireless communications unit (25) for further display and statistic analysis; moreover, when the cover body (31) over the can body (30) is lost, a sounding demand activated by the appliance (60) is transmitted to the wireless communications unit (25) via the wireless communications technology so that an acoustic response for finding the cover body (31) is emitted by the speaker unit (26) of the electronic module (20).

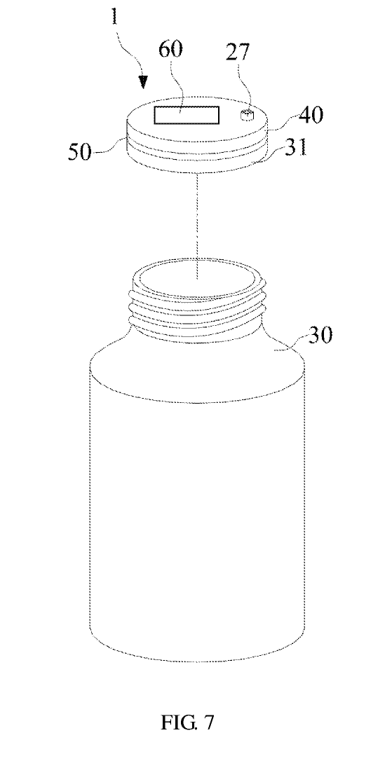

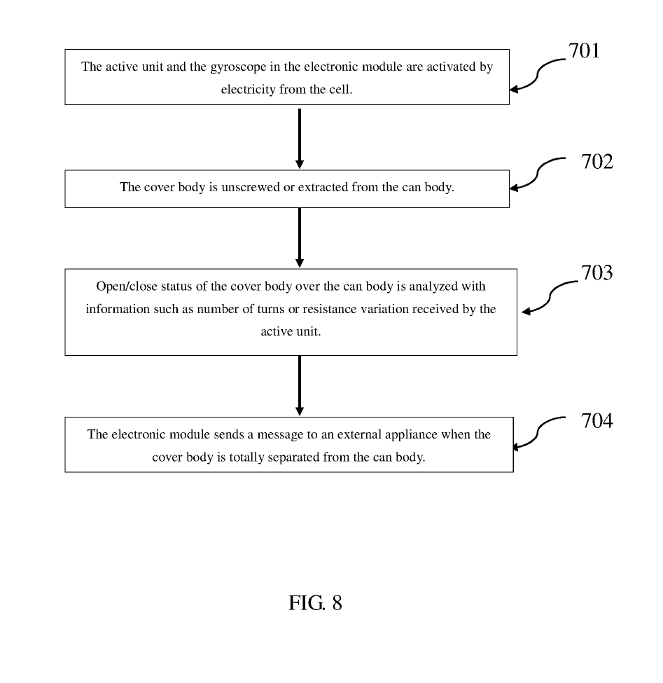

Referring to FIGS. 5 and 7 which illustrate a measuring device of the present disclosure in the third embodiment in which the symbols identical to those of the first embodiment from FIG. 1 to FIG. 3 are not explained hereinafter. The difference in the third embodiment is extra parts added in the electronic module (20) for further interactivity but no wireless communications unit (25) required.

Referring to FIGS. 5 and 7 which illustrate at least a push button (27) and a recording unit (28) are added into the electronic module (20) and the appliance (60) is a display unit electrically connected to the substrate (23) and shown on the exterior of the cover body (31).

Specifically, as shown in FIGS. 5 and 7, both the cell (10) and the electronic module (20) are protected and mounted in the housing (40) and fixed on the cover body (31) through the connection interface (50) at a side wall of the housing (40) wherein the cover body (31) can be situated at the opening of the can body (30); electronic components on the substrate (23) are electrically conducted by the cell (10); the push button (27) and the appliance (60) are shown on the exterior of the cover body (31) for convenient interactivity through a measuring device in the present disclosure; open/close status of the can body (30) is recognized when information such as displacement from the gyroscope (21) is received by the active unit (22) and conformity with defined conditions (for example, turning 360 degrees counterclockwise); a message (29) such as frequency, occurrence time or object held inside is transmitted to an appliance (60) from the electronic module (20) and displayed outside.

Accordingly, a measuring device in the present disclosure, which differs from other devices as counters mounted on containers, is referred to as creative work for applications in recognizing how many times a container is used, meets patentability, and is applied for the patent.

It should be reiterated that the above descriptions presents preferred embodiments, and any equivalent change in specifications, claims, or drawings still belongs to the technical field within the present disclosure with reference to claims hereinafter.

What is claimed is:

1. A measuring device (1), comprising a cell (10) and an electronic module (20):
the electronic module (20) with a gyroscope (21), an active unit (22) and a substrate (23) which is electrically connected to the cell (10), the gyroscope (21) and the active unit (22);
characterized in that: the electronic module (20) is mounted on a cover body (31) over a can body (30) for electric conduction of the gyroscope (21) and the active unit (22) via the cell (10) when the can body (30) needs to be opened/closed; the active unit (22) is to recognize open/close status of the can body (30) according to information such as displacement sent back by the gyroscope (21).

2. A measuring device as claimed in claim 1 wherein the measuring device (1) comprises a housing (40) to accommodate the cell (10) and the electronic module (20) at one side.

3. A measuring device as claimed in claim 2 wherein the measuring device comprises a connection interface (50) at a side wall of the housing (40).

4. A measuring device as claimed in claim 1 wherein the electronic module (20) comprises a wireless communications unit (25) electrically connected to the substrate (23).

5. A measuring device as claimed in claim 1 wherein the electronic module (20) comprises a speaker unit (26) electrically connected to the substrate (23).

6. A measuring device as claimed in claim 1 wherein the electronic module (20) comprises at least a push button (27) electrically connected to the substrate (23) and shown on the exterior of the cover body (31).

7. A measuring device as claimed in claim 1 wherein the electronic module (20) comprises a recording unit (28) electrically connected to the substrate (23).

8. A measuring device as claimed in claim 1 wherein the electronic module (20) comprises an appliance (60) electrically connected to the substrate (23) and shown on the exterior of the cover body (31).

9. A measuring device as claimed in claim 8 wherein the appliance (60) can be a display unit, a mobile phone, a tablet computer, a laptop computer or a watch.

10. An execution method of a measuring device to recognize open/close status of a cover body (31) over a can body (30) in which a cell (10) and an electronic module (20) are held and comprise steps as follows:
step 1: the active unit (22) and the gyroscope (21) in the electronic module (20) are activated by electricity from the cell (10);
step 2: the cover body (31) is unscrewed or extracted from the can body (30);
step 3: open/close status of the cover body (31) over the can body (30) is analyzed with information such as number of turns or resistance variation received by the active unit (22);
step 4: the electronic module (20) sends a message to an appliance (60) when the cover body (31) is totally separated from the can body (30).

11. A method as claimed in claim 10 wherein the message (29) in step 4 comprises information such as frequency, occurrence time or object held inside.
